(19) United States
(12) Patent Application Publication
(10) Pub. No.: US 2026/0024094 A1
(43) Pub. Date: Jan. 22, 2026

(54) AI ONBOARDING IN A CONTENT DELIVERY SYSTEM

(71) Applicant: DISH Network L.L.C., Englewood, CO (US)

(72) Inventor: Christopher Kuhrt, Englewood, CO (US)

(73) Assignee: DISH Network L.L.C., Englewood, CO (US)

(21) Appl. No.: 18/776,099

(22) Filed: Jul. 17, 2024

(51) Int. Cl. G06Q 30/015; G06F 9/451; H04N 21/442; H04N 21/45; H04N 21/854

(52) U.S. Cl. CPC G06Q 30/015; G06F 9/451; H04N 21/44222; H04N 21/4532; H04N 21/854

(57) ABSTRACT

A process for generating and presenting instructional content using a machine-learning system can include the step of monitoring a playback device to log user interactions with a service to a user interaction table (UIT) and to log operational data of the service to a health server. Baseline interaction values are identified for the service. The user interactions and the operational data are compared with the baseline interaction values to determine an interaction with the service is inefficient. Hardware and software of the playback device used to interact with the service are identified. The process includes generating instructional content for using the service in response to determining the interaction with the service is inefficient. The instructional content includes images of an interface of the identified hardware and software of the playback device.

### TECHNICAL FIELD

The present application relates generally to onboarding new services to users. Various embodiments may be used in connection with television services, telecommunication services, or other digital user services to present onboarding content to users using artificial intelligence or machine learning.

### BACKGROUND

Customers of remotely consumed products are often introduced to new services, whether by modifications to their subscription levels or by new services offered by the service provider. One persistent challenge that arises with the introduction of these innovations is the customers' unfamiliarity with navigating and utilizing these new services. In a content delivery network, for example, new features and functionalities can enhance the viewing experience for customers, though some customers experience an acclimation period before successfully adopting new services. Despite the potential benefits these advancements offer, such as improved content discovery, interactive experiences, and personalized recommendations, subscribers can find themselves overwhelmed or confused by the complexity of accessing and efficiently using new offerings.

Existing approaches to customer education can fall short in some instances, relying on static user manuals or sporadic customer support assistance. Such techniques may not adequately cater to the diverse needs and learning preferences of subscribers. Moreover, the rapid pace of technological advancements means that these traditional methods quickly become outdated, leading to continued frustration and dissatisfaction among users. Some users can be left behind as remotely-consumed technology matures.

### BRIEF DESCRIPTION

Various embodiments relate to processes, computing systems, devices, and other aspects of generating and presenting instructional content using a machine-learning system. An example process can include the step of monitoring a playback device to log user interactions with a service to a user interaction table (UIT) and to log operational data of the service to a health server. Baseline interaction values are identified for the service. The user interactions and the operational data are compared with the baseline interaction values to determine an interaction with the service is inefficient. Hardware and software of the playback device used to interact with the service are identified. The process includes generating instructional content for using the service in response to determining the interaction with the service is inefficient. The instructional content includes images of an interface of the identified hardware and software of the playback device.

In various embodiments, the instructional content for using the service is generated in response to identifying the service as newly available on the playback device. The instructional content can be delivered through the playback device or through a peripheral device. The instructional content can comprise a video tutorial, an interactive simulation, or a text-based guide.

Other devices, systems, and automated processes may be formulated in addition to those described in this brief description.

### DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example content delivery system for generating and delivering training content, in accordance with various embodiments;

FIG. 2 illustrates an example process for training an artificial intelligence (AI) or machine learning (ML) system to deliver instructional content relating to a content delivery system, in accordance with various embodiments; and

FIG. 3 illustrates an example process for generating and delivering instructional content relating to a content delivery system, in accordance with various embodiments.

### DETAILED DESCRIPTION

The following detailed description is intended to provide several examples that will illustrate the broader concepts set forth herein, but it is not intended to limit the invention or applications of the invention. Furthermore, there is no intention to be bound by any theory presented in the preceding background or the following detailed description.

The present disclosure relates to methods and systems for onboarding consumers of remote services (e.g., streaming television customers) to use new services. Leveraging interactive tutorials, intuitive user interfaces, and personalized learning pathways, various embodiments provide subscribers with a dynamic and engaging educational experience tailored to their individual preferences and proficiency levels. By offering step-by-step guidance, practical demonstrations, and real-time feedback, the system equips users with the confidence and competence needed to explore and exploit the full range of features offered by their service providers. Instructional content can be continuously updated and adapted to reflect particular user habits, technological advancements, and user feedback. The system enables customers to remain informed and empowered in an ever-evolving digital landscape.

Various embodiments generate onboarding content for delivery to customers exposed to new services using machine learning (ML) or artificial intelligence (AI) techniques. The AI/ML systems described herein can use set-top-box health (STB health) data and user behavior data from a user interaction table (UIT) to identify inefficiencies in user interactions with a service. User interactions can be aggregated and analyzed across a service to identify typical trouble spots suitable for enhanced onboarding training. In some examples, user data is analyzed on an individual basis to identify a particular user's trouble spots for further instructional content. Once identified, the AI/ML systems can subsequently generate onboarding content tailored to the user's behavior to improve the user's interaction with the new service. The AI/ML engine can deliver video, audio, text, tutorials, instructional screen manipulations, or other instructional content to users.

Suitable training sets can include file locations, data streams, tags, columns, date ranges, or other data suitable for identifying a data source and selecting the desired data from the data source. The machine generated content can be delivered to an STB, smartphone, computing device, or other device suitable for interacting with a service provider over a network. By utilizing AI and machine learning techniques, content built to address specific user behavior can be automated with limited human intervention. Examples of suitable AI techniques to implement the systems described herein include perceptron, feed forward, multilayer perceptron, convolutional, radial basis functional, recurrent, long short-term memory, sequence to sequence, or modular neural networks. ML implementations may be supervised, semi-supervised, unsupervised, or reinforcement based and can use algorithms such as naive Bayes classifier, k means clustering, support vector, linear regression, logistic regression, neural networks described above, decision trees, random forests, or nearest neighbors.

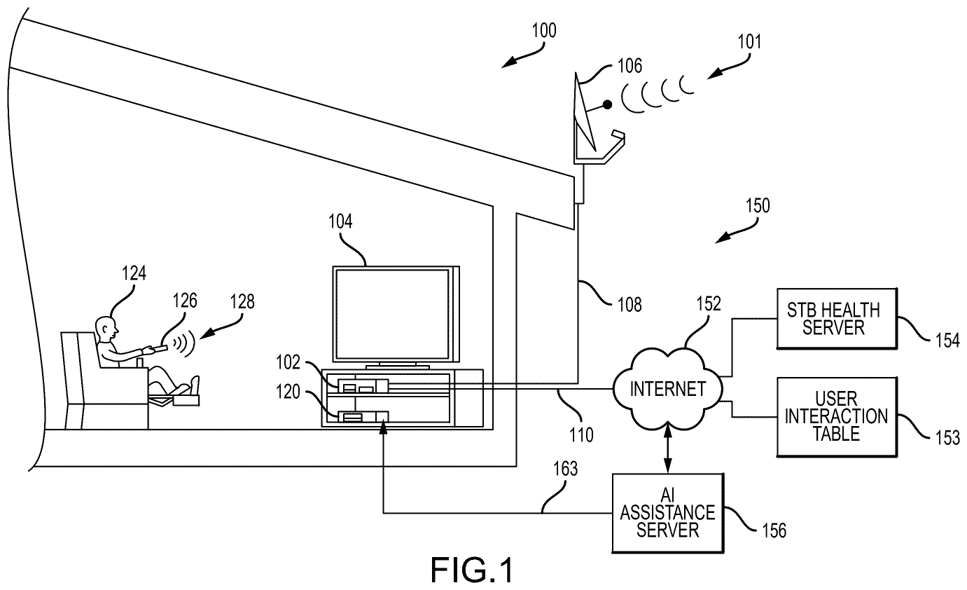

Referring now to FIG. 1, an example content delivery system 100 is shown, according to various embodiments. Content delivery system 100 can be in communication with an onboarding assistance system 150. Content delivery system 100 includes playback device 102 communicatively coupled to a source of media content, for presentation on a display 104. Playback device 102 can comprise a set-top box (STB), computing device, smartphone, smart television, streaming device, or other suitable device capable of receiving media content. Content can be delivered to playback device 102 as a media signal 101. In the exemplary embodiment shown in FIG. 1, content delivery system 100 comprises a home media entertainment system. Media signal 101 can comprise a satellite or broadcast signal received by antenna 106, and the onboarding assistance system 150 is associated with a satellite television subscription service. Playback device 102 is a set top box in the example of FIG. 1 and is configured to receive media content from antenna 106 via a communication channel 108.

While media signal 101 is depicted as a wireless broadcast or satellite signal in the example of FIG. 1, content can also be delivered over the internet, physical wire, or other mediums capable of communicating media to playback device 102. For example, playback device 102 can receive media content via an antenna which receives terrestrial broadcast signals. Alternatively, playback device 102 can receive media content via the media signal 101 received from a streaming content provider via a broadband internet service. In another example, playback device 102 can receive media content via media signal 101 received from the Internet 152 via a communication channel 110.

In various embodiments, playback device 102 can be coupled to a display 104. For example, display 104 can comprise a television or hardware built into playback device 102. Display 104 can include audio speakers or can be coupled to separate audio speakers. As used herein, the term “for display” or similar terms can mean presentation of an audio component or a video component of media signal 101. Communication channels 108 and 110 can comprise wired or wireless connections. For example, communication channels 108 and 110 can include an internet connection, a wireless connection, a cellular connection, a one-way broadcast connection, a satellite broadcast connection, a terrestrial broadcast connection, or any other type of communication channel suitable for delivering content or data to playback device 102.

Content delivery system 100 can be in communication with one or more peripheral devices 120 such as a media playback devices including, but not limited to, a stereo, a television, a game console, a tablet, a computing device, a DVR device, a smartphone, or another device capable of electronic communication over a network. Peripheral device 120 may provide an alternate source of content directly to display 104 or to a secondary display device. Any of the peripheral devices 120 can be subscriber-owned devices, or they can be supplied by the media subscription service. In one example, peripheral device 120 is a smartphone with a secondary display built into the device. AI assistance server 156 can deliver content to peripheral device 120 over alternative communication channel 163. AI Assistance server 156 may include one or more standalone servers, virtualized servers, distributed computing clusters, containers, networked computing devices, cloud services, or other computing device capable of communicating with playback device 102 over a network. Alternative communication channel 163 can include an internet connection, a wireless connection, a cellular connection, or any other type of communication channel suitable for delivering content to peripheral device 120.

The remote control 126 can be operated by a user such as subscriber 124, to cause playback device 102 to display received content on the display 104. Although remote control 126 is depicted as a typical television remote in the example of FIG. 1, remote control 126 can comprise any device or application capable of navigating the user interface of content delivery system 100. For example, remote control 126 may comprise keyboards, mice, smartphones, integrated buttons, touchpads, touchscreens, a control app running on a separate computing device, or other control hardware or software.

The remote control 126 may also be used by a viewer to display a programming guide and to communicate program selections to playback device 102. Remote control 126 is communicatively coupled to playback device 102 via a wireless path 128, for example, an infrared (IR) signal. Remote control 126 can be used to send commands to the satellite playback device 102, including channel selections, display settings, and DVR instructions. Wireless path 128 can use, for example, infrared or UHF transmitters within the remote control 126.

In various embodiments, remote control 126 can be configured to send signals to peripheral devices 120 included in content delivery system 100. Playback device 102 may also be able to send signals to remote control 126, including, but not limited to, signals to configure remote control 126 to operate the other peripheral devices 120 in the content delivery system 100. Remote control 126 can navigate various interfaces to browse content, access websites, select services, or otherwise manage content delivery system 100.

User interactions with content delivery system 100 by remote control 126 or other interaction tools or techniques are logged into a user interaction table (UIT 153). In some examples, UIT 153 can be integrated into playback device 102 or peripheral device 120, though UIT 153 is hosted on a service-provider-side server in the example of FIG. 1. User interactions and navigation, as well as start points, intermediate points, and end points of navigation, can be reconstructed and evaluated from the log in UIT 153. In some examples, user interaction flows stored in UIT 153 can be compared to typical flows or ideal flows to move from the same start point to the same end point. The comparison can result in identification of user inefficiencies in interacting with content delivery system 100.

In various embodiments, playback device 102 can be coupled by communication channel 110 and internet 152 to onboarding assistance system 150. Onboarding assistance system 150 includes UIT 153, health server 154, and AI assistant server 156. Assistance support system 150 can generate instructional content to assist subscriber 124 in using hardware components, software components, or other components included in content delivery system 100.

Various embodiments of health server 154 and UIT 153 may comprise or be stored in, for example, an unstructured data store, a structured data store, a data warehouse, data lakes, a relational database, a flat file, a JSON file, or any other technology suitable for storing and retrieving data based on columns, tags, references, or other indexing techniques. Data stored in health server 154 or UIT 153 may be a raw data stream incoming from a third-party data service, from computing devices on a network, from sensors, from a data stack, or from raw data sources. Other data sources ingestible into health server 154 or UIT 153 may include files, a file system, local storage, network storage, cloud storage, data retrievable through an application programming interface (API), web data, or other data retrievable from a third party.

Various electronic devices and computing devices described herein may comprise a processor in communication with a non-transitory computer-readable memory or other media. The memory may store instructions thereon that, when executed by the processor, cause the processor to perform operations to support the functionality of content delivery system 100 described herein. For example, health server 154 and AI assistance server 156 can comprise individual servers configured with processors, memory, permanent storage, network interfaces, and other computing components. In some examples, health server 154 and AI assistance server 156 can run in virtualized systems on cloud servers. Although AI assistance server 156 accesses various data sources and generates AI or ML content in the example embodiment depicted in FIG. 1, playback device 102, peripheral device 120, or other computing devices may equivalently access the data sources and generate instructional content.

In various embodiments, onboarding support system 150 may monitor the health of the subscriber's installed equipment, including relevant pieces of content delivery system 100 and, upon recognizing potential weak points or breaking points in the system, notify subscriber 124 of potential corrective actions. In some embodiments, AI-generated instructional content is transmitted to playback device 102 or peripheral device 120 for consumption by user 124.

Health server 154 may monitor various components in content delivery system 100, continuously evaluate its health and performance, and store maintenance and system health records in a health server database. System health data may be accessed and analyzed in conjunction with UIT data by AI assistance server 156 to identify potential user experience improvements. AI assistance server 156 can then generate instructional content specific to the user's equipment and content consumption preferences.

Health server 154 collects data on the health and operational status of installed hardware and software within content delivery system 100. Health server 154 may store the data in a local database or using other known data storage techniques. Health data can be collected via the Internet 152, which is coupled to the content receiver playback device 102 and also coupled to the remote control 126. Health server 154 may also collect data via alternative communication channel 163. Health server 154 communicates with the AI assistance server 156 via the Internet 152, another wide-area network (WAN), a local-area network (LAN), a telephony network, a public or private network of any sort, a cellular network, or any over other suitable communication network capable of updating AI assistance server 156 on the health of the system. Health server 154 also provides data to AI assistance server 156 for analysis.

With user-specific data from the health server 154 or UIT 153, AI assistance server 156 identifies areas for customer instruction tailored to user 124. AI assistance server 156 may poll, query, or otherwise lookup identifying information for the installed hardware, software, and services available to user 124. Instructions may be generated using images of actual interface screens, actual hardware, and actual software available to user 124. User 124 can be associated with the receiver ID of playback device 102. User 124 can be associated with a user account. The user account or receiver ID can be used to index data associated with user 124.

Health server 154 can actively collect data on all aspects of the content receiver system via continuous monitoring during operation. For example, health server 154 may monitor the strength of the signal received by antenna 106 and passed to playback device 102. Health server 154 may also receive weather reports regarding the weather conditions for that particular subscriber, and store this as live content in order to recognize whether heavy rain, snow, or wind conditions may be affecting the receipt of a satellite signal at the receiving antenna 106. Health server 154 may monitor and compare the strength of the signal received by receiving antenna 106 with the strength of the signal received by playback device 102 in order to determine whether there is a weak signal received by playback device 102 despite a relatively strong signal arriving at the receiving antenna 106, thus recognizing in advance the potential for some type of loose wire, worn wire, or a potential for a hardwire defect between receiving antenna 106 and playback device 102.

In various embodiments, health server 154 may continuously monitor various components inside playback device 102 or communicate with playback device 102. Various embodiments can present corrective actions for specific equipment in response to health data indicating a problem with hardware, software, or services available to user 124. Various embodiments can present instructive content for specific equipment in response to health data indicating a user has access to new hardware, software, or services or is otherwise struggling to engage existing hardware, software, or services.

In various embodiments, health server 154 also monitors the condition and operation of remote control 126. Since remote control 126 interacts with playback device 102, health server 154 can monitor the health and operation of remote control 126, wireless path 128, battery charge, keyboard functions, and other associated hardware, software, or features. Such operational data can be checked and stored in health server 154. AI assistance server 156 may, for example, determine that the battery level in remote control 126 is low and may fail or otherwise impede performance based on data stored in health server 154. AI assistance server 156 may identify the likelihood that a problem may occur, recognize the criticality of the likely problem, and generate instructional content for user 124 to implement preventative or corrective actions to address the likely problem. In various embodiments, health server 154 may proactively send a signal to AI assistance server 156 to prompt it to assess system health. In some embodiments, health server 154 may poll or query health server 154 at predetermined intervals or in response to triggering events to assess system health.

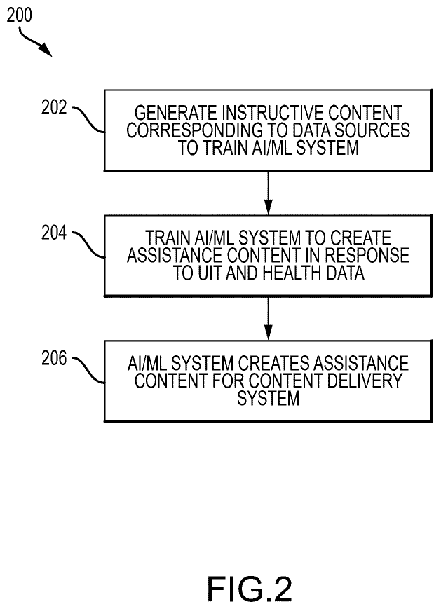

With reference to FIG. 2, an example process 200 is shown for training a generative AI/ML system to generate instructional content for users, in accordance with various embodiments. Process 200 can include the step of generating instructive content corresponding to data from health server 154 and UTI 153 to train the AI/ML system (Block 202). Data from health server 154 and UTI 153 can be analyzed to ascertain how users are interacting with hardware, software, or other features available to the users. For example, UTI data can include a log of inputs in an interface of playback device 102. The log data can include inputs that result in no change and were futile inputs. Health server 154 can maintain log data that tracks operations and the health of various components in content delivery system 100. The system health data and UIT data inputs can be paired with corresponding outputs to form a training set for AI assistance server 156.

AI assistance server 156 can generate various types of instructional content to assist users in efficiently using hardware, software, or services. AI assistance server 156 can generate text and images in the form of a manual or slide show to assist users in using their available resources. AI assistance server 156 can generate video and audio content to assist users in using their available resources. For example, AI assistance server 156 can generate a brief video that depicts use of the same model remote, same model set top box, and same version of installed streaming software as user 124. AI assistance server 156 can thus tailor instructive content to the actual hardware, software, and services available in the content delivery system 100 of user 124. Instructional content generated for particular components of the user's system tends to be more accurate than generic instructions, which can occasionally include deprecated screenshots, dated navigation hierarchies, dead links, images of screens from different software revisions, or other misleading elements.

For example, AI assistance server 156 can analyze UTI log to determine how frequently a user is making futile inputs, and the user's frequency can be compared to baseline frequencies. Higher frequency of futile inputs than a baseline level may indicate that a user is struggling with hardware, software, services, or any other trackable component available to the user. AI assistance server 156 can identify the particular component the user is struggling with and generate instructive content on efficient use of the component. The instructive content can include instructions on use of the particular screen, with the particular remote, on the particular STB that is causing the user to make futile commands.

In another example, UTI log data can include navigation logs. Navigation logs can be analyzed to assess the efficiency of a user's interactions. Efficiency can be represented in a number of interface inputs used to affect a desired result. The user's efficiency can be compared to a baseline efficiency value or an ideal efficiency value to affect the desired result. The comparison can indicate whether a user is less efficient than expected or less efficient than ideal to cause desired results. For example, a user may take 6 inputs to navigate from a home screen of a streaming application to begin streaming a movie. The ideal efficiency might be 2 inputs, and the average user may complete the same task in 3 inputs. AI assistance server 156 can generate instructional content that instructs a user how to navigate the streaming application more efficiently using the 3-input path or the 2-input path through the user interface.

Following the data generation phase, process 200 can include training the AI/ML system to create instructional content in response to the user interaction and set-top box health data (Block 204). This training process utilizes advanced machine learning algorithms to analyze patterns within the data and iteratively refine the system's ability to generate informative and engaging content. By continuously exposing the AI/ML model to new data and feedback, the system adapts and improves over time, ensuring that the instructional content it produces remains accurate, up-to-date, and responsive to evolving user needs and preferences.

Once the AI/ML system has been trained, process 200 can enable content delivery system 100 to autonomously generate assistance content aimed at onboarding users to new services or aiding them in efficiently utilizing existing services (Block 206). Leveraging the insights gleaned from the training phase, the system creates instructional materials that are tailored to the individual user's context, presenting information in a format and style that tends to maximize comprehension and engagement. Whether through interactive videos, slide presentations, textual guides, or other media formats, the generated content serves as a valuable resource for users seeking to familiarize themselves with unfamiliar services or optimize their usage of existing ones. The AI/ML system may thus enhance the user experience by facilitating smoother transitions and maximizing the utility of the available services.

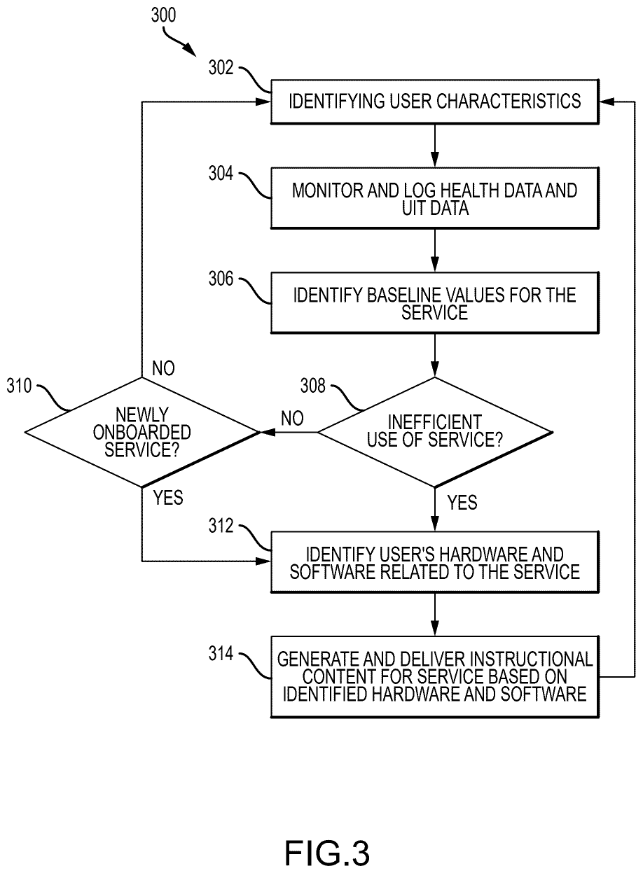

Referring now to FIG. 3, process 300 is shown for generating and delivering training content, in accordance with various embodiments. Process 300 can include identifying characteristics of user 124 (Block 302). Content delivery system 100 may use various data sources to discern user characteristics and preferences, thereby enabling personalized recommendations and tailored content experiences. User interaction data can be used to identify user characteristics. Examples of user interaction data can include browsing history, navigation logs, content consumption patterns, and engagement metrics. By analyzing which content users interact with, how often, and for how long, the service can infer their interests and preferences. Additionally, demographic data can serve as a source of insights into user characteristics such as age, gender, location, and language preferences. Contextual data such as time of day, device type, and location can be used to identify user characteristics. Explicit user feedback, including ratings, reviews, questionnaires, or explicit preferences can serve as direct indicators of user interests. Content delivery system 100 can enhance the user experience through more personalized content offerings in response to identifying user interests and preferences.

For example, a user's characteristics can be identified from historic data such as interaction logs from UIT 153. Logs may indicate that 90% of a user's interactions with content delivery system 100 is to record live sporting events and playback at a later date. AI assistance server 156 may then look for opportunities to improve the experience of user 124 in recording and playback services in content delivery system 100.

In various embodiments, process 300 can monitor and log health data and UIT data (Block 304). Monitoring playback device 102 for operational and health data can include collecting a variety of metrics and measurements to assess the device's performance and condition. This includes observing parameters such as playback duration, resolution settings, buffering times, and error rates during video playback sessions. Additionally, data related to hardware utilization, such as CPU and memory usage, network connectivity, and temperature levels, can provide insights into the device's operational efficiency and potential issues. For instance, frequent buffering or high error rates may indicate network congestion or bandwidth limitations, while elevated CPU temperatures could suggest inadequate cooling or excessive processing demands. System health monitoring can also monitor the operational condition of services or software. For example, health server 154 can log particular videos that were played, playback conditions, start times, end times, pause times, or other operational playback data. In another example, health server 154 can log screens that were shown in different applications, the display start time, the display end time, the next screen shown, user time spent on each screen, or other data related to the operation of applications on playback device 102.

Monitoring user interactions with playback device 102 may include capturing actions and behaviors exhibited by users as they navigate through the device's interface. UIT data thus encompasses various aspects of user engagement and interaction patterns, providing valuable insights into user preferences, usability issues, and overall satisfaction. One set of data logged to UIT 153 can include navigational history, which tracks the sequence of screens or menus visited by users during their sessions, the links or buttons clicked, and the overall path to navigate from a starting screen to an endpoint. Analyzing navigational history can reveal common paths taken by a user, popular features or sections of the interface, and potential areas of confusion or friction.

In addition to navigational history, other types of data that might be observed include user input data, such as clicks, swipes, and gestures, used to interact with the interface. These interactions provide insights into user behavior and preferences regarding interface elements, such as buttons, menus, and navigation bars. Furthermore, monitoring user input data allows for the identification of usability issues, such as unresponsive controls or unclear call-to-action prompts, which can be addressed through interface optimizations or design adjustments. Tracking session duration and frequency of interactions can also indicate user engagement levels and patterns of usage over time. For instance, longer session durations and frequent return visits may suggest high levels of user satisfaction and loyalty, whereas short session durations or infrequent usage could indicate dissatisfaction or disinterest. Additionally, capturing contextual data, such as device type, screen size, software revision, and network connectivity can lead to valuable context for interpreting user interactions and optimizing the interface across different environments and devices. By logging user interaction data with the interface on playback device 102 and health data of playback device 102, content delivery system 100 captures data that can be analyzed to generate insights into user behavior, preferences, and satisfaction levels. This data informs interface depictions in personalized instructional content to enhance the overall user experience and drive engagement and retention on the platform.

In various embodiments, AI assistance server 156 can identify baseline values for the service being assessed (Block 306). Identification of baseline values for user interaction with an interface can include establishing benchmarks that represent typical or ideal user behavior within the context of the video playback device. These baseline values serve as reference points against which actual user interaction data can be compared, enabling AI assistance server 156 to identify deviations, inefficiencies, or anomalies in how users engage with the interface. For instance, baseline values for navigational history could include metrics such as the average number of screens visited per action, the most commonly accessed screens or menus to achieve an action, or the typical sequence of interactions leading to specific actions, such as playback initiation or content selection. These baseline values provide a standard against which AI assistance server 156 can evaluate whether users are efficiently navigating through the interface or encountering obstacles that impede their journey.

Similarly, baseline values for user input data might encompass metrics such as the average number of interactions per session, the distribution of clicks or taps across different interface elements, and the frequency of specific gestures or commands. By establishing baselines, AI assistance server 156 can gauge whether users are engaging with the interface in a manner consistent with typical or desirable behavior, or if there are indications of frustration, confusion, or inefficiency in how they interact with the device. Baseline values for session duration and frequency of interactions can similarly help AI assistance server 156 assess user engagement levels and usage patterns relative to expected norms. For example, if the average session duration falls significantly below the baseline, it may signal a lack of interest or engagement with the content or interface, prompting AI assistance server 156 to generate and deliver instructional content to assist users.

In various embodiments, process 300 may include the step of checking whether inefficient use of the service is detected (Block 308). Inefficient service use may be detected by comparing logged user behavior from UIT 153 and system operational data from health server 154 with baseline values to identify user deviations from the baseline. User deviations can comprise inefficient navigation by taking more steps than the average user or more steps than the ideal user to affect a desired result. For example, content delivery system 100 may determine that user 124 has used 6 or more navigation steps to go from system power on to playing an episode of the same series. The ideal navigation path to affect the same result from the same starting point may be 3 navigation steps. AI assistance server 156 may thus detect inefficient navigation of user 124 in response to user 124 repeatedly taking 3 or more excess steps to play an episode of the same series.

If AI assistance server 156 does not detect inefficient use of the service, it may check whether the service is newly onboarded for the user (Block 310). Non use or efficient use may be augmented by instructional content custom tailored to the user's playback environment in response to the service being newly onboarded. If AI assistance server 156 detects inefficient use of a service in Block 308, or if AI assistance server 156 detects the service is newly onboarded for user 124 in Block 310, AI assistance server 156 may prepare to generate tailored assistance content for user 124.

In various embodiments, AI assistance server 156 may identify the hardware and software related to the service (Block 312). The hardware and software may be identified in a database maintained by the service provider. The hardware and software may be identified using techniques such as user-agent string parsing, executable code running on the hardware or software (e.g., an agent), polling, device fingerprinting, API communication, or using other active identification techniques. In some examples, user 124 is running a particular version of a streaming application or other service, and the revision number can be retrieved.

AI assistance server 156 may generate and deliver instructional content for service based on the identified hardware and software (Block 314). AI assistance server 156 can generate and deliver various types of instructional content such as, for example, text-based guides, marked up and excerpted user manuals, slides, video tutorials, interactive software simulations, reference guides, audio guides, popups, overlays, an assistant, or other content suitable for delivery to user 124 through playback device 102 or peripheral device 120.

Text-based guides, for example, can serve as foundational resources and can include detailed instructions and best practices for navigating the features and functionalities of content delivery system 100. Written guides can benefit users who prefer comprehensive written explanations and prefer to learn at their own pace, allowing them to reference materials as needed. Video tutorials can include visual demonstrations accompanied by audio narration, offering users a more dynamic and engaging way to learn than through static text. Instructional content can cover topics such as basic device setup, software navigation, and advanced tips and tricks.

In another example, video tutorials can tend to illustrate complex processes and practical applications effectively by incorporating custom visual aids that replicate the user's actual environment. Users can follow along step-by-step, pause, rewind, and replay as needed, making video tutorials effective for visual learners or those who prefer guided instruction.

In yet another example, interactive software simulations can offer hands-on learning experiences in virtual environments, simulating the user interface and functionalities of software applications. Users can interact with simulated features, receive instant feedback, and practice tasks without the risk of making mistakes in real-world applications. These simulations are valuable for users seeking practical experience and skill development in a risk-free setting. AI assistance server 156 can generate a simulation environment that replicates or approximates the actual content delivery system 100 available to user 124.

For example, AI assistance server 156 may identify that a user is operating a HOPPER PLUS device to interact with DISH Network using DVR capabilities to access previously broadcast content. AI assistance server 156 can generate written instructions with images to help the user more efficiently use the identified hardware and services, by using actual screenshots from the HOPPER PLUS interface and actual images of the default HOPPER PLUS remote control. The tailored content can assist users in navigating their particular hardware, software, and services.

Systems, methods, and devices of the present disclosure tend to improve the user experience of a remote, technology-based service. In a content delivery network, systems of the present disclosure can monitor usage of various services, hardware, and software to identify inefficiencies. The system uses an AI assistance server to generate instructional content to aid in user integration with new services or other detected challenges facing the user.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment. For example, A and B, A and C, B and C, or A and B and C.

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A process for generating and presenting instructional content using a machine-learning system, the process comprising:
monitoring a playback device to log user interactions with a service to a user interaction table (UIT) and to log operational data of the service to a health server;
identifying baseline interaction values for the service;
comparing the user interactions and the operational data with the baseline interaction values to determine an interaction with the service is inefficient;
identifying hardware and software of the playback device used to interact with the service; and
generating instructional content for using the service in response to determining the interaction with the service is inefficient, wherein the instructional content includes images of an interface of the identified hardware and software of the playback device.

2. The process of claim 1, further comprising identifying the service as newly available on the playback device.

3. The process of claim 2, wherein the instructional content for using the service is generated in response to identifying the service as newly available on the playback device.

4. The process of claim 1, further comprising delivering the instructional content through the playback device.

5. The process of claim 1, further comprising delivering the instructional content through a peripheral device.

6. The process of claim 1, wherein the instructional content comprises a video tutorial.

7. The process of claim 1, wherein the instructional content comprises an interactive simulation.

8. The process of claim 1, wherein the instructional content comprises a text-based guide.

9. A process for generating and presenting instructional content using a machine-learning system, the process comprising:
monitoring a playback device to log user interactions with a service to a user interaction table (UIT) and to log operational data of the service to a health server;
identifying baseline interaction values for the service;
assessing the user interactions and the operational data to identifying the service as newly available on the playback device;
identifying hardware and software of the playback device used to interact with the service; and
generating instructional content for using the service in response to identifying the service as newly available on the playback device, wherein the instructional content includes images of an interface of the identified hardware and software of the playback device.

10. The process of claim 9, further comprising delivering the instructional content through the playback device.

11. The process of claim 9, further comprising delivering the instructional content through a peripheral device.

12. The process of claim 9, wherein the instructional content comprises a video tutorial.

13. The process of claim 9, wherein the instructional content comprises an interactive simulation.

14. The process of claim 9, wherein the instructional content comprises a text-based guide.

15. The process of claim 9, further comprising identifying the service as newly available on the playback device.

16. A server in communication with data sources for generating and presenting instructional content using a machine-learning system, the server comprising a processor in communication with a non-transitory storage medium configured to store computer-executable instructions that, when executed by the processor, cause the server to perform operations, the operations comprising:
monitoring a playback device to log user interactions with a service to a user interaction table (UIT) and to log operational data of the service to a health server;
identifying baseline interaction values for the service;
comparing the user interactions and the operational data with the baseline interaction values to determine an interaction with the service is inefficient;
identifying hardware and software of the playback device used to interact with the service; and
generating instructional content for using the service in response to determining the interaction with the service is inefficient, wherein the instructional content includes images of an interface of the identified hardware and software of the playback device.

17. The server of claim 16, wherein the instructional content for using the service is generated in response to identifying the service as newly available on the playback device.

18. The server of claim 16, wherein the operations further comprise delivering the instructional content through the playback device.

19. The server of claim 16, wherein the operations further comprise delivering the instructional content through a peripheral device.

20. The process of claim 1, wherein the instructional content comprises a video tutorial, an interactive simulation, or a text-based guide.
